(19) United States
(12) Patent Application Publication
(10) Pub. No.: US 2013/0311255 A1
(43) Pub. Date: Nov. 21, 2013

(54) METHOD AND SYSTEM FOR DISPLAYING AND UPDATING LIMITED REDEMPTION COUPONS ON A MOBILE DEVICE

(71) Applicants: Oran CUMMINS, Dublin (IE); Garry LYONS, Dublin (IE)

(72) Inventors: Oran CUMMINS, Dublin (IE); Garry LYONS, Dublin (IE)

(73) Assignee: MasterCard International Incorporated, Purchase, NY (US)

(21) Appl. No.: 13/474,309

(22) Filed: May 17, 2012

(51) Int. Cl. G06Q 30/02

(52) U.S. Cl. 705/14.13; 705/14.1; 705/14.22; 705/14.35; 705/14.26

(57) ABSTRACT

A method for updating a limited redemption coupon includes: storing, in a database, at least one coupon record for at least one coupon, wherein the at least one coupon record includes at least a limitation on redemption associated with the at least one coupon; updating, in the database, the limitation on redemption associated with the at least one coupon in response to a limiting event; and transmitting, by a transmitting device, the updated limitation on redemption associated with the at least one coupon to at least one mobile communication device for display on the at least one mobile communication device.

### FIELD

The present disclosure relates to Gamification of electronic coupons, specifically by the real-time updating of limitations on redemption of electronic coupons stored on a mobile device.

### BACKGROUND

Over the years, coupons have become a valuable tool for manufacturers to boost sales of their products and for merchants to bring consumers into their stores. Traditionally, consumers could find coupons in newspapers, mailers, or at merchants themselves. In more recent times, the Internet has been used for the mass distribution of coupons, where consumers can receive coupons in their e-mail, or can visit a website and select coupons to print off and take in to the store. In some instances, consumers are even able to store coupons on their mobile device for presentation to the merchant.

Although coupons have made the shopping experience more convenient for consumers as time has gone on, the coupons themselves have remained largely unchanged. In most instances, when a coupon is distributed to a consumer, what the consumer sees is what they get. Most traditional coupons do not provide the consumer with any information to incentivize the use of the coupon apart from the coupon discount itself. While some coupons may provide an expiration date, which may encourage a consumer to use it to take advantage of the offer before it expires, the display of a static date may not be effective and may often times be forgotten by the consumer.

Thus, there is a perceived opportunity to improve the consumer coupon experience through Gamification using real-time data processing. Providing temporally dependent functionality and dynamic rewards as part of an effort to provide a game-like aspect to coupon redemption poses technical challenges. The integration of game mechanics into coupons can encourage consumers to take advantage of what a coupon has to offer with rewards and satisfaction not practical using traditional print coupons.

### SUMMARY

The present disclosure provides a description of a systems and methods for the distribution and updating of limited redemption coupons, thereby depending on embodiment can provide technical solutions in providing game-like aspects to coupon redemption.

A method for updating a limited redemption coupon includes: storing, in a database, at least one coupon record for at least one coupon, wherein the at least one coupon record includes at least one limitation on redemption associated with the at least one coupon; updating, in the database, the at least one limitation on redemption associated with the at least one coupon in response to a limiting event; and transmitting, by a transmitting device, the updated limitation on redemption associated with the at least one coupon to at least one mobile communication device for display on the at least one mobile communication device.

In exemplary embodiments, the at least one limitation can be one or more of a fixed number of coupons that can be redeemed, stock limit or time limit for example, which counts down or decrements as coupons are redeemed, the countdown being display on the user device.

A method for displaying a limitation on redemption of a coupon on a mobile communication device includes: displaying, on a display of the mobile communication device, at least a limitation on redemption associated with a coupon; receiving, by a receiver of the mobile communication device, an updated limitation on redemption associated with the coupon; and displaying, by the display of the mobile communication device, the updated limitation on redemption.

A system for updating a limited redemption coupon include a database, a processor, and a transmitting device. The database is configured to store at least one coupon record for at least one coupon, wherein the at least one coupon record includes at least a limitation on redemption associated with the at least one coupon. The processor is configured to update, in the database, the limitation on redemption associated with the at least one coupon in response to a limiting event. The transmitting device is configured to transmit the updated limitation on redemption associated with the at least one coupon to at least one mobile communication device for display on the at least one mobile communication device.

A mobile communication device includes a display, a receiver, and a processor. The display is configured to display at least a limitation on redemption associated with a coupon. The receiver is configured to receive an updated limitation on redemption associated with the coupon. The processor is configured to display, on the display, the updated limitation on redemption associated with the coupon.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for the distribution and updating of limited redemption coupons in accordance with exemplary embodiments.

FIG. 2 is a block diagram illustrating a mobile communication device for displaying and updating limited redemption coupons in accordance with exemplary embodiments.

FIG. 3 is a block diagram illustrating a processing server for processing coupon information and distributing and updating limited redemption coupons in accordance with exemplary embodiments.

FIGS. 4A and 4B are a processing flow illustrating a method for distributing and updating a limited redemption coupon using the system of FIG. 1 in accordance with exemplary embodiments.

FIG. 5 is a block diagram illustrating system architecture of an exemplary computer system in accordance with exemplary embodiments.

FIG. 6 is a flow chart illustrating a method for updating a limited redemption coupon in accordance with exemplary embodiments.

FIG. 7 is a flow chart illustrating a method for displaying a limitation of redemption for a coupon on a mobile device in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Updating and Distributing Limited Redemption Coupons

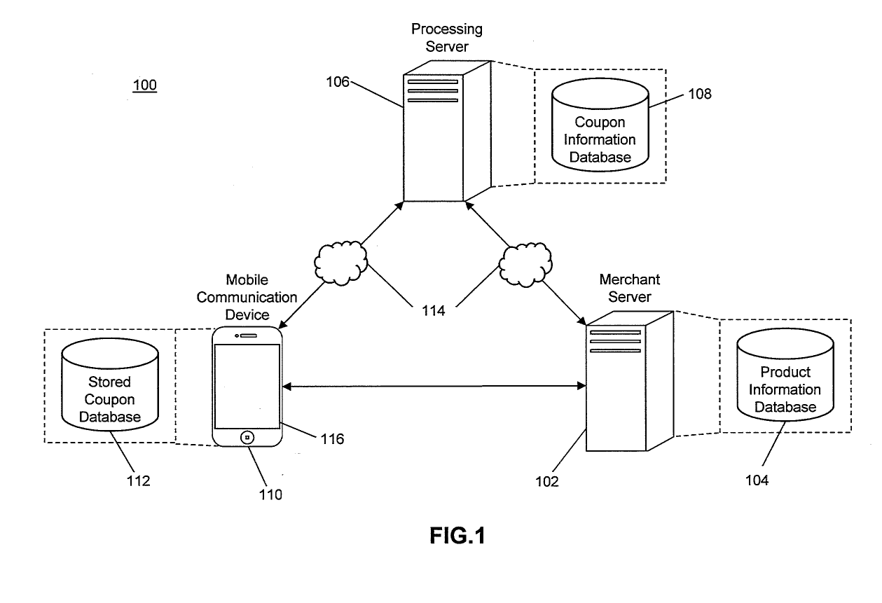

FIG. 1 illustrates a system 100 for distributing and updating limited redemption coupons on a mobile device. The system 100 may include a mobile communication device 110, a merchant server 102, and a processing server 106. The components may communicate via a network 114. The network 114 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

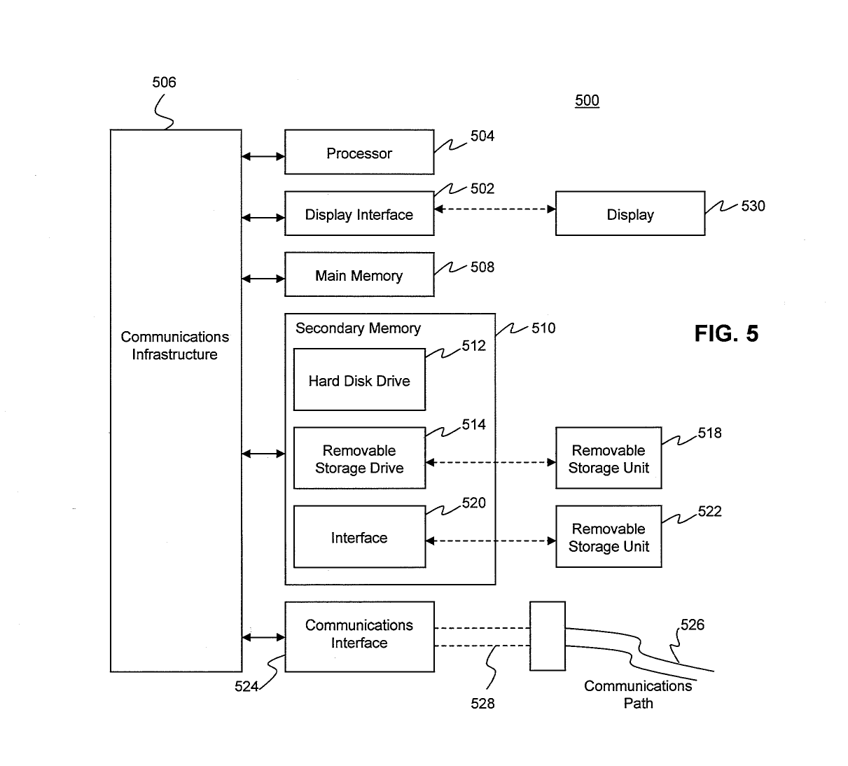

The merchant server 102 may be any type of computer system configured for performing the functions as disclosed herein as will be apparent to persons having skill in the relevant art, such as the system 500 illustrated in FIG. 5, discussed below. The merchant server 102 may be at a physical location of a merchant (e.g., in a store) or may be at a remote location. The merchant server 102 may be a single computer system or multiple computer systems interfaced together (e.g., via the network 114). The merchant server 102 may be a general computer (e.g., programmed to perform the functions disclosed herein to be a specific purpose computer), a server, or a combination thereof.

The merchant server 102 may include at least a product information database 104. The product information database 104 may include information associated with at least one product that the corresponding merchant offers for purchase. Information located in the product information database 104 will be apparent to persons having skill in the relevant art, and may include at least a product identifier, available inventory, pricing information, sizing information, etc. The product identifier may be a value unique to the associated product for the purposes of identifying the product, such as a stock-keeping unit (SKU), universal product code (UPC), European article number (EAN), manufacturer part number (MPN), serial number, international standard book number (ISBN), etc. In one embodiment, the product information database 104 may include at least a product identifier and available inventory associated with the product.

The merchant server 102 may provide coupon information for a coupon to the processing server 106 (e.g., via the network 114). Coupon information may include the product identifier and available inventory associated with a product for which the coupon may apply, as well as the amount of the coupon (e.g., $5 off, 10% off, buy-one-get-one-free, etc.), a coupon identifier, and a limitation on redemption. The limitation on redemption may be any type of limitation that may be placed on or associated with the coupon that may limit the ability for a consumer to redeem the coupon. Types of limitations on redemption that may be beneficial for use in the system 100 will be apparent to persons having skill in the relevant art and may include a quantity limit (e.g., 500 redemptions), a time limit (e.g., within 7 days), a stock limit (e.g., while supplies last), a combination thereof, a scaled redemption (e.g., first 100 redemptions get one amount, following redemptions another, etc.), etc.

The use of limitations on redemptions for electronically stored coupons may enable a merchant (e.g., via the merchant server 102 communicating with the processing server 106) to control the number of redemptions of coupon, which may not be done with traditional print coupons. For example, if inventory is running low due to unexpected demand, the merchant may notify the processing server 106 to decrease the limitation on redemption to match remaining inventory. Of course, the limitations can be increased, and regardless of which way, can be changed to influence behavior of consumers.

The processing server 106 may be any type of computer system configured for performing the functions as disclosed herein as will be apparent to persons having skill in the relevant art, such as the system 500 illustrated in FIG. 5, discussed below. The processing server 106 may be at a physical location of a merchant (e.g., in a store) or may be at a remote location. The processing server 106 may be a single computer system or multiple computer systems interfaced together (e.g., via the network 114). The processing server 106 may be a general computer (e.g., programmed to perform the functions disclosed herein to be a specific purpose computer), a server, or a combination thereof.

The processing server 106 may store the coupon information in a coupon information database 108. The coupon information database 108 may store information for a plurality of coupons, the information including at least the received coupon information. The information for each coupon may also include statistics and metrics identified (e.g., calculated) by the processing server 106, such as rates of redemption, total redemptions, total “clips” (e.g., total times the coupon has been distributed by the processing server 106 to a third party), remaining product inventory, etc.

The mobile communication device 110 may be any mobile device suitable for performing the functions as disclosed herein as will be apparent to persons having skill in the relevant art, such as a mobile device implementing the computer system 500 of FIG. 5, discussed below. The mobile communication device 110 may be a cellular phone (e.g., a smartphone), a tablet computer, a slate, a laptop computer, etc. In an exemplary embodiment, the mobile communication device 110 may be a smartphone with a capacitive touch screen display.

The mobile communication device 110 may be configured to communicate with the processing server 106 to receive (e.g., download) coupons, such as those stored in the coupon information database 108. The mobile communication device 110 may include a stored coupon database 112 configured to store the received coupons. The stored coupon database 112 may include at least the coupon identifier corresponding to the coupon. In some embodiments, the stored coupon database 112 may also store all of the information associated with the coupon included in the coupon information database 108. In other embodiments, the stored coupon database 112 may store only the coupon identifier corresponding to the coupon. In such an embodiment, the mobile communication device 110 may receive the additional information from the processing server 106 prior to display, as discussed below.

The mobile communication device 110 may display, via a display 116, a coupon stored in the stored coupon database 112. The mobile communication device 110 may also display at least the limitation on redemption associated with the coupon. In an exemplary embodiment, the mobile communication device 110 may update the limitation on redemption associated with the coupon in real-time, such as by “push” or “pull” methods of updating, as discussed in more detail below.

The coupon information database 108, the product information database 104, the stored coupon database 112, and a user information database 308, discussed below, (the “databases”) may each include data stored on any type of suitable computer readable media, such as optical storage (e.g., a compact disc, digital versatile disc, blu-ray disc, etc.) or magnetic tape storage (e.g., a hard disk drive). The database may be configured in any type of suitable database configuration, such as a relational database, a structured query language (SQL) database, a distributed database, an object database, etc. Suitable configurations and database storage types will be apparent to persons having skill in the relevant art. Each of the databases may be a single database, or may comprise multiple databases which may be interfaced together (e.g., physically or via a network, such as the network 130).

### Mobile Communication Device

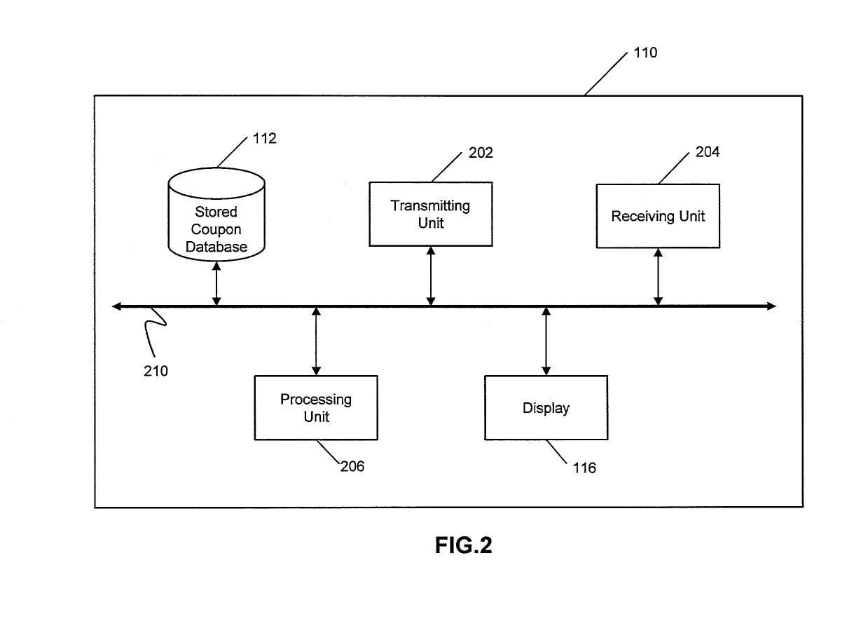

FIG. 2 illustrates a block diagram of an exemplary mobile communication device 110. The mobile communication device 110 may include at least the stored coupon database 112, a transmitting unit 202, a receiving unit 204, a processing unit 206, and the display 116. Each of the components may be connected via a bus 210. Types and configurations of the bus 210 will be apparent to persons having skill in the relevant art.

The transmitting unit 202 may be configured to transmit a request for a coupon or a request for updated coupon information. The request for a coupon, or the request for updated coupon information, may include at least a coupon identifier associated with the coupon. The coupon identifier may be a unique value (e.g., a number) associated with the coupon as to differentiate one coupon from another. The request may be transmitted via the network 114 to the processing server 106. In one embodiment, the mobile communication device 110 may automatically instruct the transmitting unit 202 to transmit the request. In another embodiment, the transmitting unit 202 may only transmit the request when manually instructed (e.g., by a user of the mobile communication device 110), or by specific operations such as opening a particular app on the mobile device.

The receiving unit 204 may be configured to receive coupon information or updated coupon information. In some instances, the coupon information may be received by the receiving unit 204 in response to a request for information (e.g., transmitted by the transmitting unit 202). In one embodiment, coupons in the stored coupon database 112 may be accessed via an application program executed by the processing unit 306. In such an embodiment, a request for updated information for each coupon, or for a specific, indicated coupon, may be transmitted by the transmitting unit 302 when the application program is executed by the processing unit 306. The received coupon information may include at least a coupon identifier associated with the coupon and a limitation on redemption. In one embodiment, the received coupon information may further include statistics and metrics associated with the coupon, such as the rate of redemption and estimated time of expiration.

The processing unit 206 may be configured to store the received coupon information in the stored coupon database 112. In instances where the received coupon information is updated coupon information, the processing unit 206 may be configured to update an entry in the stored coupon database 112 associated with the coupon, with the updated coupon information. In some embodiments, the processing unit 206 may be further configured to identify (e.g., calculate) statistics and metrics based on the received updated coupon information. For example, if a coupon is limited to 500 redemptions at a first time, and an update shows the coupon to be limited to only 300 redemptions at a second time, the processing unit 206 may calculate the rate of redemption (e.g., a number of redemptions per minute or other time period) and may further calculate an estimated time of expiration (e.g., based on the rate of redemption and updated limitation on redemption, redemption historical profiles, etc.).

The processing unit 206 may be further configured to cause the display 116 to display coupons and their associated limitations on redemption stored in the stored coupon database 112. In an exemplary embodiment, the processing unit 206 may be configured to update a display of a coupon and its associated limitation on redemption on the display 116 with updated coupon information when received (e.g., by the receiving unit 204). For example, the display 116 may show a coupon with 375 redemptions remaining, and then may indicate (e.g., via an animation) that only 374 redemptions remain after a redemption occurs, as described in more detail below. The processing unit 206 may also be configured to display received or identified statistics or metrics associated with the coupon.

In one embodiment, the receiving unit 304 may be configured to receive input via an input device (e.g., keyboard, capacitive touch screen, etc.) from a user. In an exemplary embodiment, the user may input preferences or alerts for a coupon stored in the stored coupon database 112, which may be stored (e.g., by the processing unit 206) in the coupon information associated with the corresponding coupon. For example, the user may indicate what statistics or metrics to receive and/or display for a coupon, such as displaying only the estimated time of expiration.

The user may also be able to set alerts to be alerted of predetermined events associated with a coupon. For example, the user of the mobile communication device 110 may be alerted (e.g., via the display 208) when a coupon is estimated to expire in a predetermined time (e.g., within the next hour), when a minimum number of redemptions have occurred (e.g., 100,000 consumers have redeemed the coupon), when a predetermined number of redemptions are remaining (e.g., only 100 redemptions left), etc. Other preferences and alerts that a user may input (e.g., that may be stored in the coupon information) will be apparent to persons having skill in the relevant art. These alerts and other forms of usage information can also be relevant to the merchant or industry watchers and advertisement agencies as evidence of effectiveness and return on investment, for example.

### Processing Server

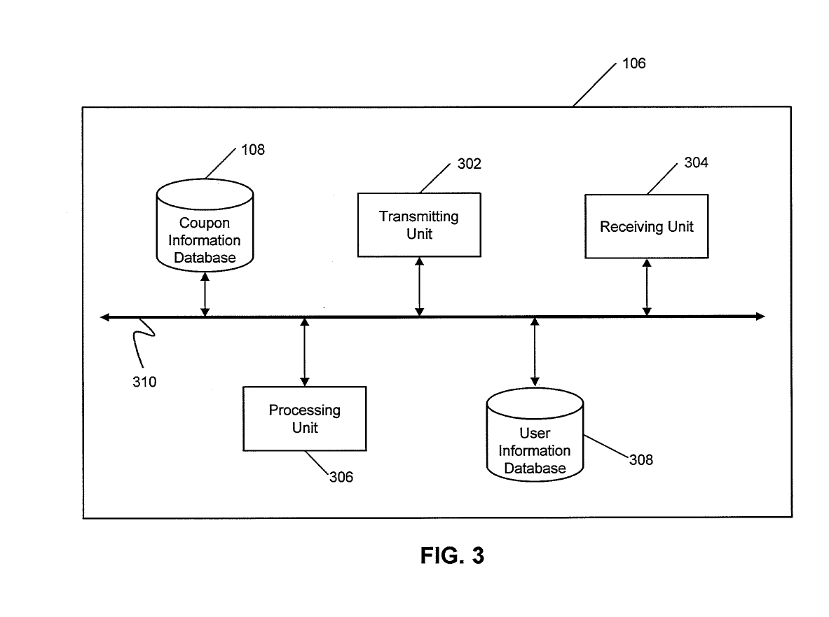

FIG. 3 is a block diagram illustrating an exemplary processing server 106. The processing server 106 may include the coupon information database 108, a transmitting unit 302, a receiving unit 304, a processing unit 306, and the user information database 308. Each of the components may be connected via a bus 310. Suitable types and configurations of the bus 310 will be apparent to persons having skill in the relevant art.

The receiving unit 304 may be configured to receive coupon information, such as from the merchant server 102. The processing unit 306 may be configured to store the received coupon information in the coupon information database 108. The coupon information may include at least a coupon identifier, a discount amount, and a limitation on redemption. In one embodiment, the coupon identifier may be identified (e.g., generated, assigned, etc.) by the processing unit 306. In another embodiment, the coupon identifier may be included in the coupon information received by the receiving unit 304.

The transmitting unit 302 may be configured to transmit coupon information for coupons stored in the coupon information database 108 to a mobile communication device, such as the mobile communication device 110. The transmitting unit 302 may also be configured to transmit updated coupon information, such as updates to limitations on redemption, to a mobile communication device 110 that has previously received a coupon. The updated coupon information may include only a coupon identifier associated with the coupon and an updated limitation on redemption.

In some embodiments the transmitting unit 202 may transmit the updated coupon information only when instructed (e.g., by the processing unit 306) in response to the receiving unit 304 receiving a request for updated coupon information (e.g., sent by the mobile communication device 110). In other embodiments the transmitting unit 202 may transmit the updated coupon information automatically, such as at predetermined time intervals (e.g., every 30 minutes, every hour, etc.). In one embodiment, the predetermined time intervals may be set by the user of the mobile communication device 110 and stored in the user information database 308, described below.

The receiving unit 304 may also be configured to receive notifications of redemption of coupons stored in the coupon information database 108. In some embodiments, the receiving unit 304 may be further configured to receive authorization requests for a financial transaction, wherein the authorization request includes at least a coupon identifier associated with a coupon stored in the coupon information database 108. In some instances in such an embodiment, the processing unit 306 may be configured to process the financial transaction. The notification of redemption may include at least the coupon identifier associated with the redeemed coupon.

Upon receipt of a notification of redemption, the processing unit 306 may be configured to update the coupon information associated with the redeemed coupon (e.g., based on the coupon identifier). Updating the coupon information may include updating the limitation on redemption of the redeemed coupon. For example, if the limitation on redemption of a coupon is 500 redemptions, and a notification of redemption is received, the processing unit 306 may decrement the limitation on redemption to 499 remaining redemptions.

The processing unit 306 may be further configured to identify (e.g., calculate) statistics and metrics based on the notification of redemption, which may be stored in the coupon information database 108 as part of the coupon information associated with the redeemed coupon. Statistics and metrics may include rate of redemption, estimated expiration, number of redemptions, redemptions remaining, and other information that may be of interest to consumers, merchants, etc. as will be apparent to persons having skill in the relevant art. In one embodiment, the statistics and metrics may be identified by the processing unit 306 upon each receipt of a notification of redemption by the receiving unit 304. In another embodiment, the processing unit 306 may identify the statistics and metrics at predetermined time intervals. In one embodiment, the transmitting unit 302 may transmit updated coupon information (e.g., including the statistics and metrics) to the mobile communication device 110 following identification of the updated statistics and metrics.

The user information database 308 may be configured to store information corresponding to a user (e.g., of the mobile communication device 110). In an exemplary embodiment, user information may only be obtained through consent (e.g., opting-in) of the user. The user information stored in the user information database 308 may include a user identifier (e.g., a unique value associated with the user, such as a financial account number, etc.), demographic information (e.g., gender, income, marital status, familial status, resident status, geographic location, etc.), financial information (transaction history, credit history, etc.), and other information that may be supplied by the user associated with the information. In an exemplary embodiment, potentially personally identifiable information may be bucketed (e.g., grouped) as to render the information not personally identifiable. For example, income may be bucketed in ranges, such as below $100,000, $100,000 to $149,999, $150,000 to $199,999, etc.

In an exemplary embodiment, the user information stored in the user information database 308 may also include user preferences. For example, in one embodiment, a user may provide a predetermined time interval for updated coupon information to be transmitted to the user's mobile communication device 110, which may be stored in the user information database 308. In another embodiment, a user may indicate what statistics or metrics to receive for a coupon, such as only receiving the estimated expiration time of redemption of the coupon.

User information stored in the user information database 308 may also be used for reporting, such as for marketing or business analytic purposes. Unlike with traditional print coupons, limited redemption coupons as disclosed herein may be associated with users and thereby associated with provided user information, which may be used for marketing or analytical purposes.

The receiving unit 304 may be configured to receive user information from the user, such as via the mobile communication device 110, a personal computer, or from an input device (e.g., keyboard, etc.). The processing unit 306 may store the received user information in the user information database 308 in an entry associated with the corresponding user. In one embodiment, the receiving unit 304 may be configured to receive requests for alerts for a coupon from a user, such as described above, which may be stored in the coupon information database 108.

Method of Distributing and Updating Coupons with a, Limitation on Redemption

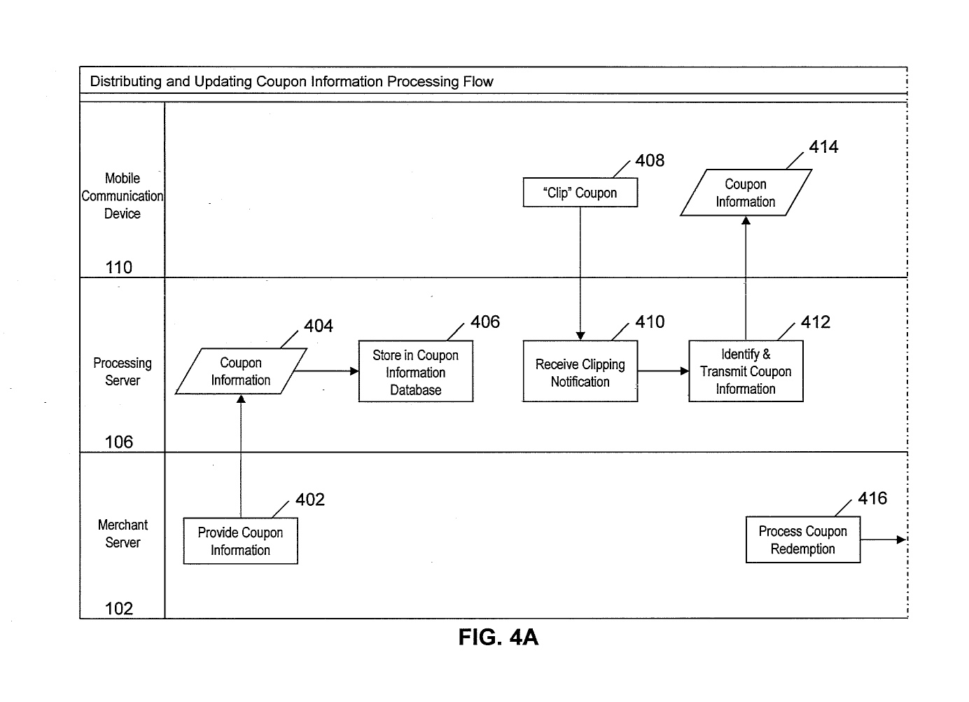

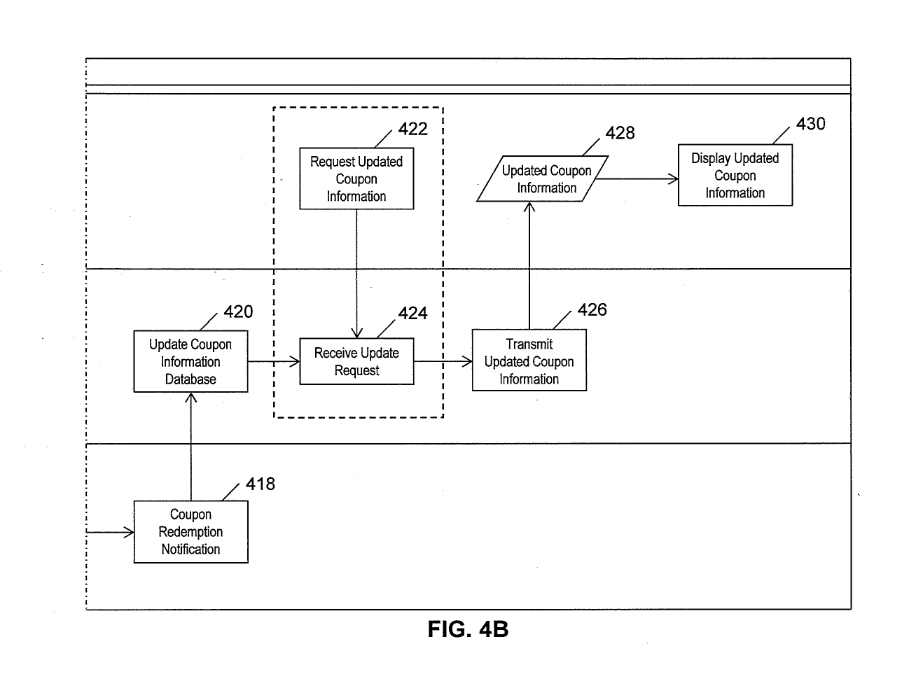

FIGS. 4A and 4B are a process flow illustrating a method for distributing and updating coupons that include at least one limitation on redemption.

In step 402, the merchant server 102 may provide coupon information for a coupon to the processing server 106. The coupon information may include at least a coupon identifier and a limitation on redemption associated with the coupon. The coupon identifier may be a value unique to the associated coupon used to identify the coupon. The limitation on redemption may be any limit on the redemption of the corresponding coupon, such as a quantity limit (e.g., will expire after 500 redemptions) or a time limit (e.g., will expire after seven days, on a particular date, active in a predetermined time period, etc.). The coupon information may also include other information related to the coupon as will be apparent to persons having skill in the relevant art, such as product information (e.g., product identifier, product name, etc.) for the product for which the coupon may be used, discount information (e.g., $5 off, 10% off, etc.), location information (e.g., where the coupon may be redeemed), etc.

In step 404, the processing server 106 may receive the coupon information (e.g., via the receiving unit 304) and may store the information in the coupon information database 108, in step 406. In an exemplary embodiment, the processing server 106 may make at least a portion of the coupon information available to mobile communication devices, such as the mobile communication device 110.

In step 408, a user may “clip” a coupon stored in the coupon information database 108 using the mobile communication device 110, which may transmit (e.g., via the transmitting unit 202) notification of the clipping to the processing server 106. The notification may include at least the coupon identifier associated with the coupon. The process of clipping the coupon may include the user browsing through available coupons (e.g., and stored in the coupon information database 108) via an application program, such as one stored and executed on the mobile communication device 110 or on a computer (e.g., a web browser), and selecting a coupon. Other methods and processes for clipping (e.g., saving) coupons stored in the coupon information database 108 will be apparent to persons having skill in the relevant art.

In one embodiment, the user may clip a coupon by reading, with a reader of the mobile communication device 110, a machine-readable code encoded with a coupon identifier, which may then be transmitted to the processing server 106. In a further embodiment, the machine-readable code may be a barcode, such as a QR code. In one embodiment the machine-readable code may be display by a dynamic display, such as in a store where the product associated with the encoded coupon may be available for purchase.

In some embodiments, when the user clips a coupon using the mobile communication device 110, such as by reading a machine-readable code, the coupon may be encoded with a time limit for transmitting to the processing server 106 and receiving coupon information. For example, a user may read a machine-readable code at a merchant location that is encoded with a coupon identifier and a limit of a predetermined time (e.g., until the dynamic display switches to a different machine-readable code) to notify the processing server 106. If the processing server 106 is notified within the predetermined time, it may continue to step 412. If the processing server 106 is not notified within the predetermined time, the mobile communication device 110 may not receive the coupon. Such an embodiment may be useful, for example, for merchants who wish to provide limited redemption coupons to consumers at a physical location of the merchant rather than allow the coupon to be shared among multiple communication devices.

In step 410, the processing server 106 may receive the notification of the clipping of the coupon. In step 412, the processing server may identify the corresponding coupon information in the coupon information database 108 and may transmit (e.g., via the transmitting unit 302) the identified coupon information to the mobile communication device 110. In one embodiment, the coupon information transmitted to the mobile communication device 110 may be based on preferences of a user associated with the mobile communication device 110 (e.g., and stored in the user information database 308). In step 414, the mobile communication device 110 may receive the coupon information, which may be stored in the stored coupon database 112. In some embodiments, the mobile communication device 110 may display (e.g., via the display 116) the coupon information (e.g., via the application program).

In step 416, the merchant server 102 may process the redemption of a coupon by engaging in a financial transaction (e.g., with a user of the mobile communication device 110) where the coupon may be used. Methods and processes for processing a coupon will be apparent to persons having skill in the relevant art, such as the merchant scanning the coupon at a point-of-sale. The merchant server 102 may, in step 418, transmit a notification that the coupon has been redeemed to the processing server 106. The notification may include at least the coupon identifier associated with the coupon. In embodiments where a coupon may be redeemed multiple times in a single transaction, the notification may further include a number of redemptions.

In step 420, the processing server 106 may receive the notification of redemption and may update (e.g., via the processing unit 306) update the coupon information for the corresponding coupon in the coupon information database 108. Updating the coupon information may include at least updating the limitation on redemption of the corresponding coupon. In one embodiment, updating the information may further include updating (e.g., by identifying, calculating, etc.) statistics and metrics associated with the corresponding coupon, as previously discussed.

In step 422, the mobile communication device 110 may request updated coupon information for at least one coupon from the processing server 106. The request may include at least the coupon identifier for each coupon for which updated information may be requested. In one embodiment, the request may include specific information requested for the corresponding coupon, such as indicated statistics or metrics. In some embodiments, the request may be initiated manually by a user of the mobile communication device 110. In other embodiments, the request may be automatically initiated by the mobile communication device 110, such as at predetermined time intervals or when an application program is executed. In step 424, the processing server 106 may receive the request for updated coupon information. It will be apparent to persons having skill in the relevant art that steps 422 and 424 may be optional steps.

In step 426, the processing server 106 may transmit the updated coupon information to the mobile communication device 110, which may receive and store the information in the stored coupon database 112, in step 428. The updated coupon information may include at least a coupon identifier and a limitation on redemption for at least one coupon. In one embodiment, the updated coupon information may include an updated limitation on redemption for each coupon stored in the stored coupon database 112. In some embodiments, the updated coupon information for a coupon may include updated statistics and metrics associated with the coupon.

In step 430, the mobile communication device 110 may display (e.g., via the display 116) the updated coupon information (e.g., via an application program executed by the processing unit 206). In one embodiment, the mobile communication device 110 may display the updated limitation on redemption in place of the previous limitation on redemption. For example, if a coupon was display as having 500 redemptions remaining, and the updated limitation on redemption was 499 redemptions remaining, an animation of the 500 redemptions decrementing to 499 may be displayed. Similarly, if the limitation on redemption is a time, the mobile communication device 110 may count down and/or to the time.

The updating, transmitting, and displaying of statistics and metrics associated with a coupon may operate as game mechanics to enhance the consumer experience. For example, displaying a high rate of redemption to a consumer may encourage them to not only use the coupon, but to do so sooner. Additionally displaying an estimated time of expiration may further encourage a consumer to redeem the coupon before it expires or else lose out on the potential savings. Displaying the total number of redemptions may also enhance the consumer experience, as the consumer may discover that a large number of people are redeeming the coupon and would thus not want to miss out on the deal that so many others have received. Providing the statistics and metrics for display to the consumer in real-time or near real-time may further enhance the consumer experience. Identifying, transmitting and displaying statistics and metrics associated with a coupon to a user in possession of the coupon in or near real-time may be performed using the methods or systems as disclosed herein, which may improve over limitations of traditional print and electronic coupons.

### System Architecture

FIG. 5 illustrates a computer system 500 in which embodiments of the present disclosure, or portions thereof, may be implemented as computer-readable code. For example, the merchant server 102, processing server 106, and mobile communication device 110 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4 and 6-7, discussed herein.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device. The processor device 504 may be connected to a communication infrastructure 506, such as a bus, message queue, network (e.g., the network 122), multi-core message-passing scheme, etc. The computer system 800 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive, the removable storage unit 518 may be a floppy disk. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

Computer program medium and computer usable medium may refer to memories, such as the main memory 508 and secondary memory 510, which may be memory semiconductors (e.g. DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 4 and 6-7 as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

### Exemplary Method of Updating a Limited Redemption Coupon

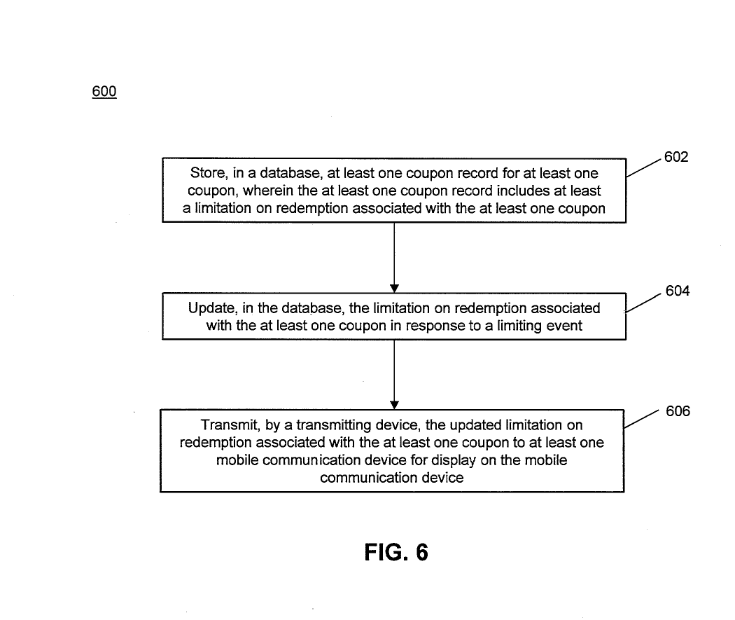

FIG. 6 illustrates a method 600 of updating a limited redemption coupon. In step 602, at least one coupon record for at least one coupon may be stored in a database (e.g., the coupon information database 108), wherein the at least one coupon record includes at least a limitation on redemption associated with the at least one coupon. In one embodiment, the limitation on redemption may be a limited number of times the associated coupon may be redeemed. In another embodiment, the limitation on redemption may be a time period during which the associated coupon may be redeemed. In yet another embodiment, the limitation on redemption may be a predetermined time at which the associated coupon will expire.

In one embodiment, the limitation on redemption may be a limited number of times the associated coupon may be redeemed during a predetermined time period. In another embodiment, the limitation on redemption may be a limited number of times the associated coupon may be redeemed during a recurring time period. In a further embodiment, the limited number of times may be reset at each recurrence of the recurring time period.

In step 604, the limitation on redemption associated with the at least one coupon may be updated, in the database, in response to a limiting event. In one embodiment, the limiting event may be the massive of a predetermined time or time period. In another embodiment, the limiting event may be the receiving, by a receiving device (e.g., the receiving unit 304), of a notification of at least one redemption of the at least one coupon. In yet another embodiment, the limiting event may be the receiving, by a receiving device, of an authorization request for a financial transaction, wherein the financial transaction includes at least a notification of redemption of the at least one coupon. In a further embodiment, the authorization request may be in compliance with the ISO 8583 standard. In one embodiment, updating the limitation on redemption may further include updating statistics and metrics associated with the at least one coupon.

In step 606, the updated limitation on redemption associated with the at least one coupon may be transmitted, by a transmitting device (e.g., the transmitting unit 302) to at least one mobile communication device (e.g., the mobile communication device 110) for display (e.g., via the display 116) on the mobile communication device. In one embodiment, transmitting the updated limitation on redemption may further include transmitting statistics and metrics associated with the at least one coupon. In a further embodiment, the statistics and metrics may include at least one of: rate of redemption, estimated time of expiration, number of redemptions, and percentage of redemptions. In one embodiment, the method 600 may further include receiving, by a receiving device, a request for the updated limitation on redemption from the at least one mobile communication device, wherein transmitting the updated limitation on redemption includes transmitting the updated limitation on redemption in response to receiving the request for the updated limitation on redemption.

### Method for Displaying a Limitation on Redemption of a Coupon

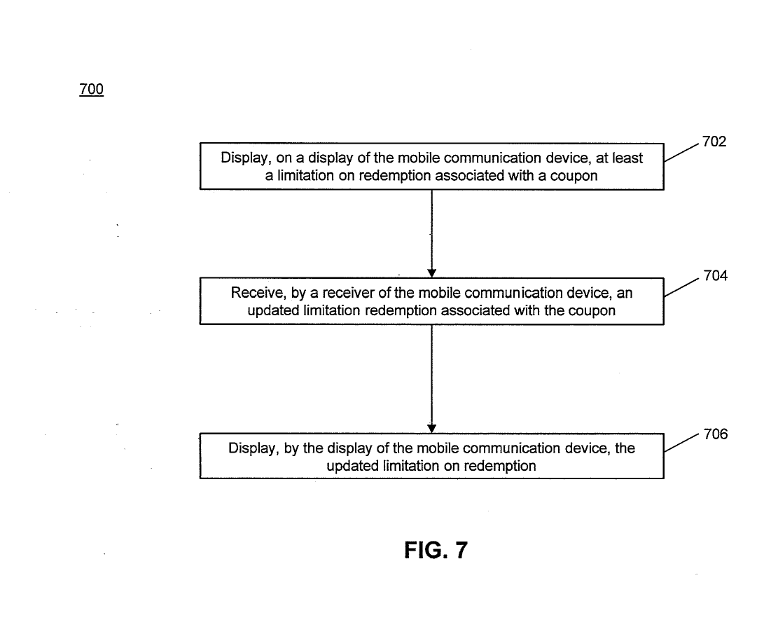

FIG. 7 illustrates a method 700 for display a limitation on redemption of a coupon on a mobile communication device. In step 702, at least a limitation on redemption associated with a coupon may be displayed on a display (e.g., the display 116) of a mobile communication device (e.g., the mobile communication device 110). In one embodiment, the limitation on redemption may be a limited number of times the associated coupon may be redeemed. In another embodiment, the limitation on redemption may be a time period during which the associated coupon may be redeemed. In yet another embodiment, the limitation on redemption may be a predetermined time at which the associated coupon will expire.

In one embodiment, the limitation on redemption may be a limited number of times the associated coupon may be redeemed during a predetermined time period. In another embodiment, the limitation on redemption may be a limited number of times the associated coupon may be redeemed during a recurring time period. In a further embodiment, the limited number of times may be reset at each recurrence of the recurring time period.

In step 704, an updated limitation on redemption associated with the coupon may be received by a receiver (e.g., the receiving unit 204) of the mobile communication device 110. In one embodiment, receiving the updated limitation on redemption may further include receiving statistics and metrics associated with the at least one coupon. In a further embodiment, the statistics and metrics may include at least one of: rate of redemption, estimated time of expiration, number of redemptions, and percentage of redemptions.

In step 706, the updated limitation on redemption may be displayed by the display 116 of the mobile communication device 110. In one embodiment, the updated limitation on redemption may be displayed in place of the limitation on redemption. In one embodiment, displaying the updated limitation on redemption may further include displaying the received statistics and metrics.

In one embodiment, the method 700 may further include transmitting, by a transmitter (e.g., the transmitting unit 202) of the mobile communication device 110, a request for the updated limitation on redemption associated with the coupon, wherein receiving the updated limitation on redemption includes receiving the updated limitation on redemption in response to the request for the updated limitation on redemption. In a further embodiment, the method 700 may include reading, by a reader of the mobile communication device 110, a machine-readable code, wherein the machine-readable code is encoded with at least an identifier associated with the coupon and the request for the updated limitation on redemption associated with the coupon includes at least the identifier associated with the coupon. In an even further embodiment, the machine-readable code may be a bar code. In yet a further embodiment, the bar code may be a QR code.

Techniques consistent with the present disclosure provide, among other features, systems and methods for distributing content to devices, initiating financial transactions, processing electronic financial transactions using a payer device and pay codes, and indirectly controlling websites. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for updating a limited redemption coupon, comprising:
storing, in a database, at least one coupon record for at least one coupon, wherein the at least one coupon record includes at least a limitation on redemption associated with the at least one coupon;
updating, in the database, the limitation on redemption associated with the at least one coupon in response to a limiting event; and
transmitting, by a transmitting device, the updated limitation on redemption associated with the at least one coupon to at least one mobile communication device for display on the at least one mobile communication device.

2. The method of claim 1, wherein the limitation on redemption is a limited number of times the associated at least one coupon may be redeemed.

3. The method of claim 2, wherein the limiting event is the receiving, by a receiving device, of an authorization request for a financial transaction, wherein the financial transaction includes at least a notification of redemption of the at least one coupon.

4. The method of claim 3, wherein the authorization request is in compliance with the ISO 8583 standard.

5. The method of claim 2, wherein the limiting event is the receiving, by a receiving device, of a notification of at least one redemption of the at least one coupon.

6. The method of claim 1, wherein the limitation on redemption is predetermined time period during which the associated at least one coupon may be redeemed.

7. The method of claim 6, wherein the limiting event is the passage of the predetermined time period.

8. The method of claim 1, wherein the limitation on redemption is a limited number of times the associated at least one coupon may be redeemed during a predetermined time period.

9. The method of claim 1, wherein the limitation on redemption is a limited number of times the associated at least one coupon may be redeemed during a recurring time period.

10. The method of claim 9, wherein the limited number of times the associated at least one coupon may be redeemed is reset at each recurrence of the recurring time period.

11. The method of claim 1, further comprising:
receiving, by a receiving device, a request for the updated limitation on redemption from the at least one mobile communication device, and
wherein transmitting the updated limitation on redemption includes transmitting the updated limitation on redemption in response to receiving the request for the updated limitation on redemption.

12. The method of claim 1, wherein updating the limitation on redemption associated with the at least one coupon further includes updating statistics and metrics associated with the at least one coupon in response to the limiting event.

13. The method of claim 1, wherein transmitting the updated limitation on redemption associated with the at least one coupon further includes transmitting statistics and metrics associated with the at least one coupon.

14. The method of claim 13, wherein the statistics and metrics includes at least one of: rate of redemption, estimated time of expiration, number of redemptions, percentage of redemptions, and demographic information of redeemers.

15. A method for displaying a limitation on redemption of a coupon on a mobile communication device, comprising:
displaying, on a display of the mobile communication device, at least a limitation on redemption associated with a coupon;
receiving, by a receiver of the mobile communication device, an updated limitation on redemption associated with the coupon; and
displaying, by the display of the mobile communication device, the updated limitation on redemption.

16. The method of claim 15, wherein the updated limitation on redemption is displayed in place of the limitation on redemption.

17. The method of claim 15, wherein the limitation on redemption is a limited number of times the associated coupon may be redeemed.

18. The method of claim 15, wherein the limitation on redemption is a predetermined time period during which the associated coupon may be redeemed.

19. The method of claim 15, wherein the limitation on redemption is a limited number of times the associated coupon may be redeemed during a predetermined time period.

20. The method of claim 15, wherein the limitation on redemption is a limited number of times the associated coupon may be redeemed during a recurring period of time.

21. The method of claim 15, further comprising:
transmitting, by a transmitter of the mobile communication device, a request for the updated limitation on redemption associated with the coupon, and
wherein receiving the updated limitation on redemption includes receiving the updated limitation on redemption as a response to the request for the updated limitation on redemption.

22. The method of claim 21, further comprising:
reading, by a reader of the mobile communication device, a machine-readable code, wherein the machine-readable code is encoded with at least an identifier associated with the coupon, and
wherein the request for the updated limitation on redemption associated with the coupon includes at least the identifier associated with the coupon.

23. The method of claim 22, wherein the machine-readable code is a bar code.

24. The method of claim 23, wherein the bar code is a QR code.

25. The method of claim 15, wherein receiving the updated limitation on redemption associated with the coupon further includes receiving statistics and metrics associated with the coupon.

26. The method of claim 25, wherein the statistics and metrics include at least one of: rate of redemption, estimated time of expiration, number of redemptions, and percentage of redemptions.

27. The method of claim 25, wherein displaying the updated limitation on redemption associated with the coupon further includes displaying the received statistics and metrics associated with the coupon.

28. A system for updating a limited redemption coupon, comprising:
a database configured to store at least one coupon record for at least one coupon, wherein the at least one coupon record includes at least a limitation on redemption associated with the at least one coupon;
a processor configured to update, in the database, the limitation on redemption associated with the at least one coupon in response to a limiting event; and
a transmitting device configured to transmit the updated limitation on redemption associated with the at least one coupon to at least one mobile communication device for display on the at least one mobile communication device.

29. The system of claim 28, wherein the limitation on redemption is a limited number of times the associated at least one coupon may be redeemed.

30. The system of claim 28, wherein the limiting event is the receiving, by a receiving device, of an authorization request for a financial transaction, wherein the financial transaction includes at least a notification of redemption of the at least one coupon.

31. The system of claim 30, wherein the authorization request is in compliance with the ISO 8583 standard.

32. The system of claim 29, wherein the limiting event is the receiving, by a receiving device, of a notification of at least one redemption of the at least one coupon.

33. The system of claim 28, wherein the limitation on redemption is predetermined time period during which the associated at least one coupon may be redeemed.

34. The system of claim 33, wherein the limiting event is the passage of the predetermined time period.

35. The system of claim 28, wherein the limitation on redemption is a limited number of times the associated at least one coupon may be redeemed during a predetermined time period.

36. The system of claim 28, wherein the limitation on redemption is a limited number of times the associated at least one coupon may be redeemed during a recurring time period.

37. The system of claim 28, wherein the limited number of times the associated at least one coupon may be redeemed is reset at each recurrence of the recurring time period.

38. The system of claim 28, further comprising:
a receiving device configured to receive a request for the updated limitation on redemption from the at least one mobile communication device, and
wherein transmitting device is further configured to transmit the updated limitation on redemption in response to the receiving device receiving the request for the updated limitation on redemption.

39. The system of claim 28, wherein the processor is further configured to update, in the database, statistics and metrics associated with the at least one coupon in response to the limiting event.

40. The system of claim 39, wherein the statistics and metrics include at least one of: rate of redemption, estimated time of expiration, number of redemptions, and percentage of redemptions.

41. The system of claim 39, wherein the transmitting device is further configured to transmit the updated statistics and metrics associated with the at least one coupon to the at least one mobile communication device for display on the mobile communication device.

42. A mobile communication device, comprising:
a display configured to display at least a limitation on redemption associated with a coupon;
a receiver configured to receive an updated limitation on redemption associated with the coupon; and
a processor configured to display, on the display, the updated limitation on redemption associated with the coupon.

43. The mobile communication device of claim 42, wherein the updated limitation on redemption is displayed in place of the limitation on redemption.

44. The mobile communication device of claim 42, wherein the limitation on redemption is a limited number of times the associated coupon may be redeemed.

45. The mobile communication device of claim 42, wherein the limitation on redemption is a predetermined time period during which the associated coupon may be redeemed.

46. The mobile communication device of claim 42, wherein the limitation on redemption is a limited number of times the associated coupon may be redeemed during a predetermined time period.

47. The mobile communication device of claim 42, wherein the limitation on redemption is a limited number of times the associated coupon may be redeemed during a recurring period of time.

48. The mobile communication device of claim 42, further comprising:
a transmitter configured to transmit a request for the updated limitation on redemption associated with the coupon, and
wherein the receiver is further configured to receive the updated limitation on redemption as a response to the transmitter transmitting the request for the updated limitation on redemption.

49. The mobile communication device of claim 48, further comprising:
a reader configured to read a machine-readable code, wherein the machine-readable code is encoded with at least an identifier associated with the coupon, and
wherein the request for the updated limitation on redemption associated with the coupon includes at least the identifier associated with the coupon.

50. The mobile communication device of claim 49, wherein the machine-readable code is a bar code.

51. The mobile communication device of claim 50, wherein the bar code is a QR code.

52. The mobile communication device of claim 42, wherein the receiver is further configured to receive statistics and metrics associated with the coupon.

53. The mobile communication device of claim 52, wherein the statistics and metrics include at least one of: rate of redemption, estimated time of expiration, number of redemptions, and percentage of redemptions.

54. The mobile communication device of claim 52, wherein the processor is further configured to display, on the display, the received statistics and metrics associated with the coupon.
